(19) United States
(12) Patent Application Publication
(10) Pub. No.: US 2008/0240766 A1
(43) Pub. Date: Oct. 2, 2008

(54) IMAGE FORMING DEVICE

(75) Inventor: Eiji SUGIHARA, Kyoto-shi (JP)

Correspondence Address: MURATA MACHINERY, LTD.;(MURATEC) c/o KEATING & BENNETT LLP, 1800 Alexander Bell Drive, SUITE 200, MCLEAN, VA, 20191, US

(73) Assignee: MURATA MACHINERY, LTD., Kyoto-shi (JP)

(21) Appl. No.: 12/045,144

(22) Filed: Mar. 10, 2008

(30) Foreign Application Priority Data
Mar. 27, 2007 (JP) 2007-080717

(51) Int. Cl. G03G 15/00

(52) U.S. Cl. 399/81

(57) ABSTRACT

A method of controlling a job interruptible image forming device in which job interrupting is enabled, includes a step of storing contents of respective job settings of an interrupted first job and an interrupting second job respectively, a step of causing a display to indicate that the respective job settings of the first job and the second job coexist, and a step of activating job setting windows for respective job settings selectively on the display in response to a selection entry of a user.

### CROSS-REFERENCE TO RELATED APPLICATIONS

This application claims priority under 35 U.S.C. 119 to Japanese Patent Application No. 2007-080717, filed on Mar. 27, 2007, which application is hereby incorporated by reference in its entirety.

### BACKGROUND OF THE INVENTION

1. Field of the Invention

The present invention relates to an interrupt operation enabled image forming device.

2. Description of the Related Art

In the related art, an image forming device in which a so-called interrupt operation is enabled such that a first user suspends a job, then a second user executes a new job, and the first user restarts the job after having ended the new job has been in practical use.

With the device in the related art, in a case in which the interrupt operation is performed on a single operating screen such as a touch panel, when the user selects the interrupt operation, a display screen is switched to a new screen, and a previously displayed screen is hidden. Therefore, the user may be confused in the following circumstance.

For example, the first user leaves the image forming device while a job is being executed.

Then, the second user executes an interrupt job, and leaves the image forming device.

The first user returns back to the image forming device, and tries to restart the interrupted job.

In this case, even when the first user discovers that the displayed items or settings in the display are changed, he/she might get confused and, consequently, cancel all the jobs or settings and restart the job from the beginning.

### SUMMARY OF THE INVENTION

In order to overcome the problems described above, preferred embodiments of the present invention enable a user to restart his/her job without confusion even though his/her job is interrupted by an interrupt job.

A preferred embodiment of the present invention provides a job interruptible image forming device including a job setting storing unit arranged to store contents of respective job settings of an interrupted first job and an interrupting second job, a display controller arranged to display that the respective job settings of the first job and the second job coexist, and a selective activating unit arranged to activate job setting windows for the respective job settings selectively on the display in response to a selection entry of a user.

According to a preferred embodiment of the present invention, the display controller preferably controls the display to cause the respective job settings to coexist by displaying respective identifiers of the first job and the second job in parallel.

According to another preferred embodiment of the present invention, the display controller preferably controls the display to display the job setting window for the second job so as to hide at least a body portion of the setting display of the job setting window for the first job.

According to another preferred embodiment of the present invention, the display controller preferably controls the display to display the respective job setting windows for the first job and the second job in parallel.

According to another preferred embodiment of the present invention, the display controller preferably controls the display to display the active job setting window so as to be identifiable from between the respective job setting windows displayed in parallel.

An image forming device according to a preferred embodiment of the present invention preferably includes a user specific information storage unit arranged to store (a) identification information of the respective users of the image forming device and (b) job setting content specific for the respective users of the image forming device, and an authenticating unit arranged to authenticate the users stored in the user specific information storage unit, wherein the display controller controls the display when the user is authenticated by the authenticating unit to display the user specific job setting content with the user identifier.

An authenticating unit according to a preferred embodiment of the present invention preferably includes at least one of 1) a password accepting unit arranged to accept passwords, 2) a biometrics information acquiring unit arranged to accept biometrics information, 3) an identification (ID) scanning unit arranged to scan an ID from an ID storage device, and 4) an IP address acquiring unit arranged to acquire an Internet Protocol (IP) address specific for a communication terminal which is connected to the image forming device via a network, wherein the user specific information storage unit accepts a change of the user identification information stored in the user specific information storage unit and the user specific job setting content only when the user is authenticated by the authenticating unit.

A selective activating unit according to a preferred embodiment of the present invention preferably activates the user job setting window on the display only when the user is authenticated by the authenticating unit.

An image forming device according to a preferred embodiment of the present invention preferably includes a storage time limiting unit arranged to allow the job setting storage unit to store the job setting content of the first job only for a predetermined time period from a moment when a job interrupt command of the second job is entered.

According to another preferred embodiment of the present invention, the respective setting content of the interrupted first job and the interrupting second job are preferably stored, the coexistence thereof is indicated on the display, and any one of the job settings is activated in response to the entry of the user selection. Therefore, when the user restarts the interrupted job, the user is able to restart the job without confusion.

According to another preferred embodiment of the present invention, the display is preferably controlled to cause the respective job settings to coexist by displaying respective identifiers of the first job and the second job in parallel. Therefore, the user is able to restart the job without confusion.

According to another preferred embodiment of the present invention, the job setting window for the second job is preferably displayed so as to hide at least the body portion of the setting display of the job setting window for the first job. Therefore, even when a plurality of job settings coexist, the windows are displayed in substantially the same size as the job setting window displayed when a single job is being executed.

According to another preferred embodiment of the present invention, the display is preferably controlled to display the job setting windows respectively for the first job and the second job in parallel. Therefore, the user is able to recognize the coexistence of the plurality of job settings easily.

According to another preferred embodiment of the present invention, the display is preferably controlled to display the active job setting window so as to be identifiable from between the respective job setting windows displayed in parallel. Therefore, the user is able to execute the job without confusion.

According to another preferred embodiment of the present invention, when the user is authenticated by the authenticating unit, the display is preferably controlled to display the user specific job setting content with the user identifier attached thereto. Therefore, even when the job is interrupted, the job can be restarted without confusion.

According to another preferred embodiment of the present invention, the authenticating unit preferably authenticates the user by at least one of the password, the biometrics information, the ID, and the IP address of the communication terminal connected via the network, and the user specific information storage unit accepts the change of the user identification information and the user specific job setting content stored in the user specific information storage unit only when the user is authenticated by the authenticating unit. Therefore, the respective users are able to use the image forming device comfortably and without being confused.

According to another preferred embodiment of the present invention, the job setting window of the user is preferably activated on the display only when the user in question is authenticated by the authenticating unit. Therefore, other users are prevented from changing the setting content. Accordingly, the user is able to restart the job without confusion.

According to another preferred embodiment of the present invention, the storage time limiting unit is preferably arranged to allow the job setting storage unit to store the job setting content of the first job only for a predetermined time period from the moment when the job interrupt command of the second job is entered. Therefore, effective use of a limited number of registered jobs is enabled with a reduced memory capacity.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a perspective view illustrating an exemplary configuration of a multifunction peripheral device according to a first preferred embodiment of the present invention.

FIG. 2 is a block diagram illustrating the exemplary configuration of the multifunction peripheral device according to the first preferred embodiment of the present invention.

FIG. 3 is a table of display items displayed on a display of the multifunction peripheral device according to the first preferred embodiment of the present invention.

FIG. 4 illustrates the display content displayed on the display of the multifunction peripheral device according to the first preferred embodiment of the present invention.

FIG. 5 is a functional block diagram illustrating a case in which a job interrupt command is entered to the multifunction peripheral device according to the first preferred embodiment of the present invention.

FIG. 6 is a flowchart of a job interrupt process in the multifunction peripheral device according to the first preferred embodiment of the present invention.

FIG. 7 is a block diagram illustrating an exemplary configuration of the multifunction peripheral device according to a second preferred embodiment of the present invention.

FIG. 8 is a table of specific settings of the multifunction peripheral device according to the second preferred embodiment of the present invention.

FIG. 9 illustrates display content displayed on the display of the multifunction peripheral device according to the second preferred embodiment of the present invention.

FIG. 10 is a functional block diagram of a case in which a user interrupt command is entered to the multifunction peripheral device according to the second preferred embodiment of the present invention.

FIG. 11 is a flowchart of a user interrupt process in the multifunction peripheral device according to the second preferred embodiment of the present invention.

### DETAILED DESCRIPTION OF PREFERRED EMBODIMENTS

### First Preferred Embodiment

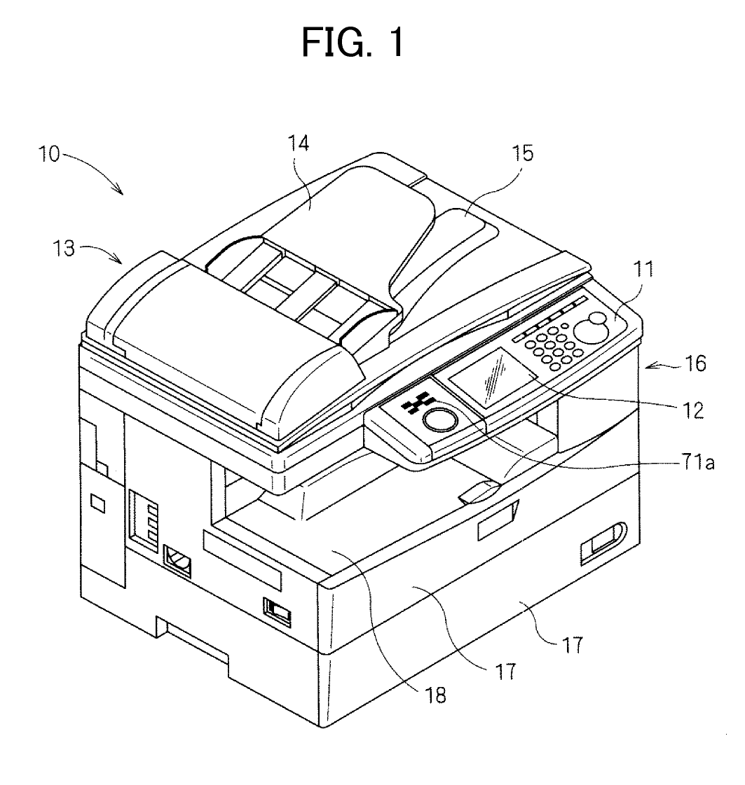

Referring now to the drawings, a Multi Function Peripheral (MFP) device having functions of a scanner, a printer, and a facsimile machine together will be described as an image forming device according to a first preferred embodiment of the present invention. FIG. 1 and the other figures illustrate only elements and/or functions relating to preferred embodiments of the present invention.

### Configuration of Multifunction Peripheral Device 10

FIG. 1 is a perspective view illustrating an exemplary configuration of multifunction peripheral device 10 according to a first preferred embodiment of the present invention. The multifunction peripheral device 10 is preferably used for scanning a document, generating an image data, and printing the image data on recording paper, or for transmitting the image data or the like with respect to communication terminals connected via a network and printing out the image data stored in the communication terminals, or for transferring the image data to other communication terminals.

An entry operation unit 11 receives an entry operation of a user, and includes mechanical switches such as a ten-keypad required for operating the multifunction peripheral device 10 and various function keys. The entry operation unit 11 accepts job interrupt commands as well as execution commands for various commands such as scanning and copying of the documents through operation of the keys by the user.

A display 12 is a general display composed of a display device such as a liquid crystal display (LCD) or the like, and displays image information and the like required for operating the multifunction peripheral device 10. A touch panel display is provided on the display 12, and supplements or subsidizes part or all of the functions of the entry operation unit 11.

A scanning unit 13 scans documents placed on a copy tray 14 having an Automatic Document Feeder (ADF) by an imaging device such as a charge coupled device (CCD) line sensor (not shown) or the like in sequence, and generates image data on the basis of the images recorded on the documents. The scanned documents are discharged to a document discharge tray 15. The documents do not have to be scanned by the ADF, and may be scanned in a Flat Bed Scanner (FBS) system. The FBS system executes a scanning sequence including the steps of scanning a document placed on a contact glass (not shown) with an image pickup device and discharging the scanned document.

An image drawing or printing unit 16 is, for example, an electrophotographic system, for printing out and recording image data generated by the scanning unit 13 or transmitted from a communication terminal connected via a network as a hard copy. Although detailed illustration thereof is omitted, toner is supplied from a toner cassette attached to a photoconductive drum on the basis of the image data. Then, the attached toner is transferred to recording paper transported from a recording paper cassette 17 by a recording paper transporting unit, and the transferred recording paper is discharged to a recording paper discharge tray 18.

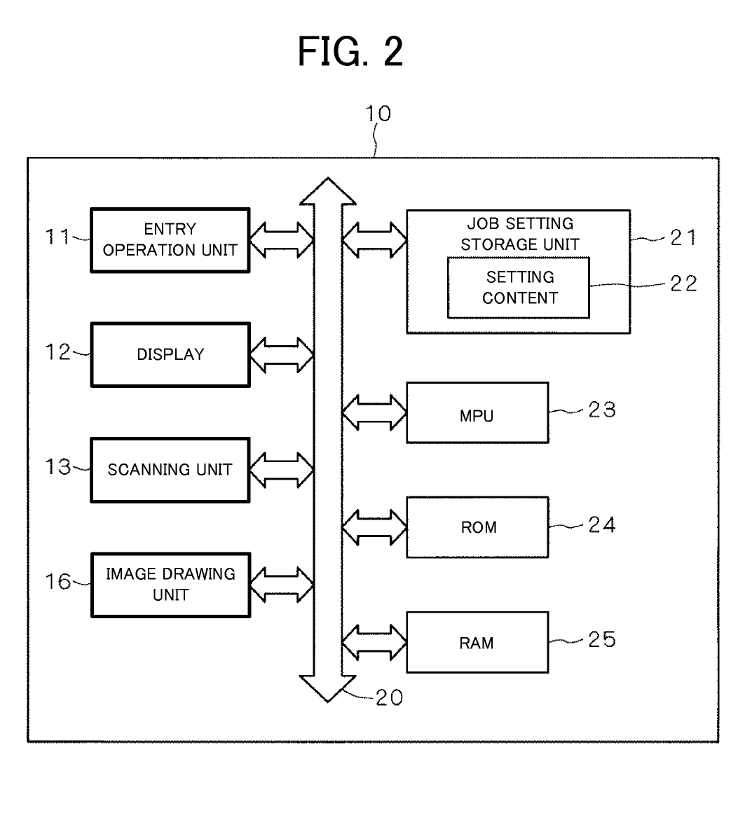

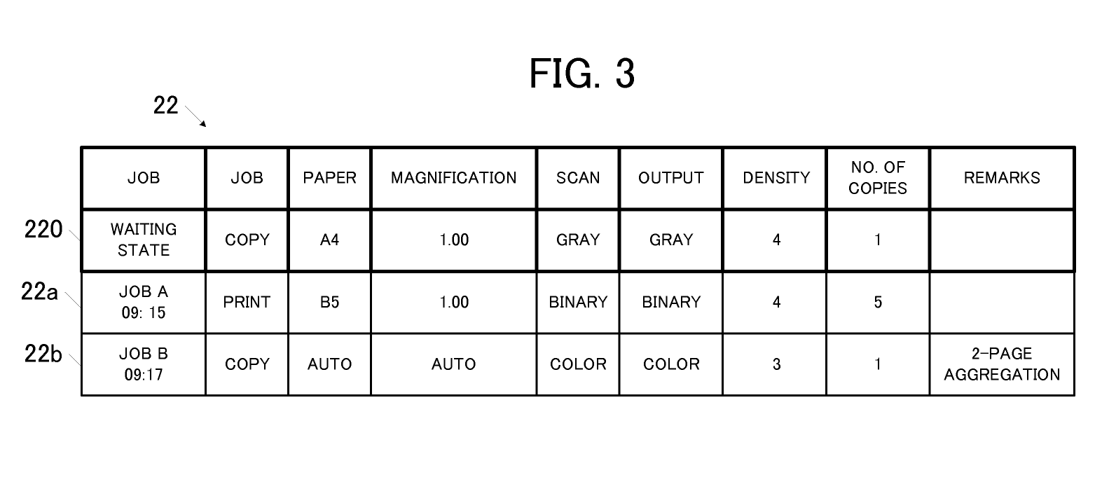

FIG. 2 is a block diagram illustrating an exemplified configuration of the multifunction peripheral device 10, and FIG. 3 is a table of setting content 220. The components described above are all electrically connected via a bus 20 and are also connected electrically with the following components.

A job setting storage unit 21 is preferably provided with a nonvolatile memory and stores, for example, a predetermined waiting screen (for example, a logo); the default setting content 220 displayed when the user executes a given entry operation from the entry operation unit 11 when the waiting screen is displayed; and, when a job interrupt command is entered through the entry operation unit 11 when the setting content of a job A (first job) is being accepted and a job B (second job) interrupts the job A, setting content 22a of the job A which is set until immediately before the job interrupt command is entered; and a setting content 22b of the job B. The setting contents 22a and 22b which are stored in a setting content section 22 in the job setting storage unit 21 include jobs such as copying, printing, or facsimile transmission; the paper size and the scaling magnification applied when the image drawing unit 16 prints out the data; image types of the scanned image from the scanning unit 13 or the printed-out image from the image drawing unit 16 such as color images, gray scale images, and binary images; the printing density; and the number of copies. The default setting content 220 includes, for example, copying job, A4 size paper, magnification (×1.00), gray scale scanning, gray scale output, density 4, and 1 copy. The date and time of storage in the job setting storage unit 21 are also stored.

The setting content section 22 holds the setting content stored in the job setting storage unit 21 when the job interrupt command is entered for a predetermined time period by the execution of a time limiting program by a Microprocessor Unit (MPU) 23. More specifically, the holding time of the setting content is, for example, on the order of about 10 minutes, and it is preferable to hold the setting content at least for a time period longer than an estimated time period until a job discontinued by the entry of the job interrupt command is restarted (no-operation period). However, a configuration in which an arbitrary time is entered and set as the holding time when the time period required for the job executed when the job interrupt command is entered (hereinafter, referred to as “interrupting job”) is estimated to be longer than 10 minutes is also applicable.

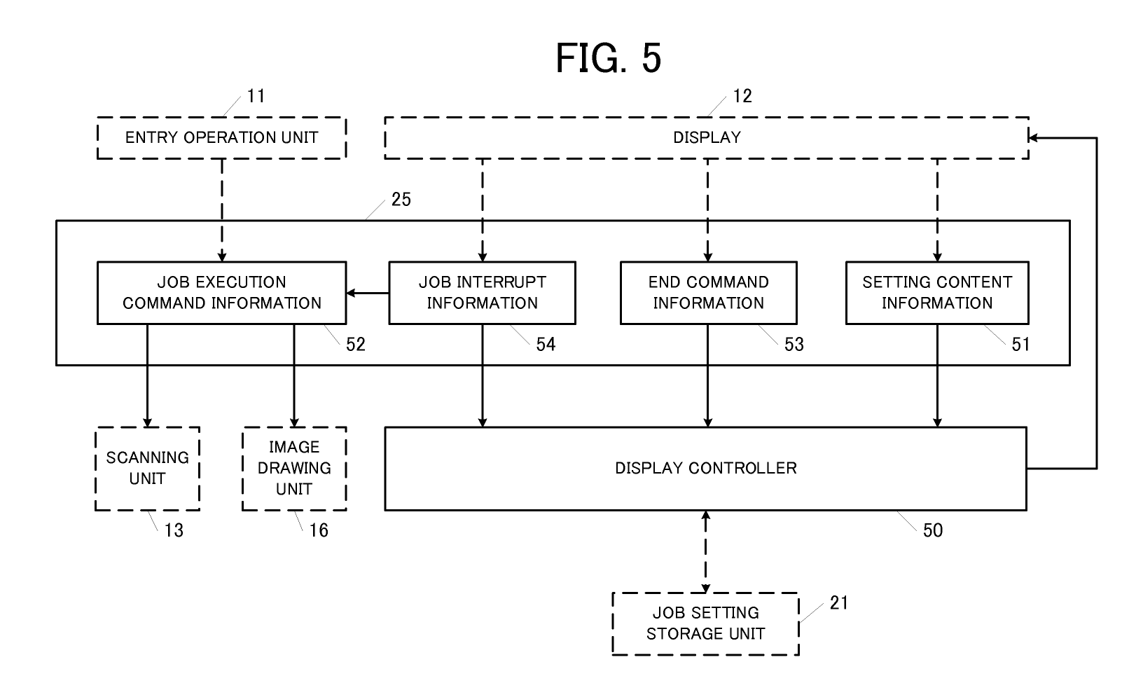

The MPU 23 controls entered signals such as execution commands from the entry operation unit 11, data calculation on the basis of the entered signals, generation of output signals, items displayed on the display 12, the scanning unit 13, the image drawing unit 16, and a display controller 50 (see FIG. 5). A Read Only Memory (ROM) 24 stores programs executed by the MPU 23 and data required for the control executed by the MPU 23, and a Random Access Memory (RAM) 25 temporarily stores data required for total control executed by the MPU 23. Consequently, the respective functions of the multifunction peripheral device 10 are achieved. In other words, the MPU 23 controls the respective components of the multifunction peripheral device 10 in association with the ROM 24 and the RAM 25.

### Function of the Display Controller 50

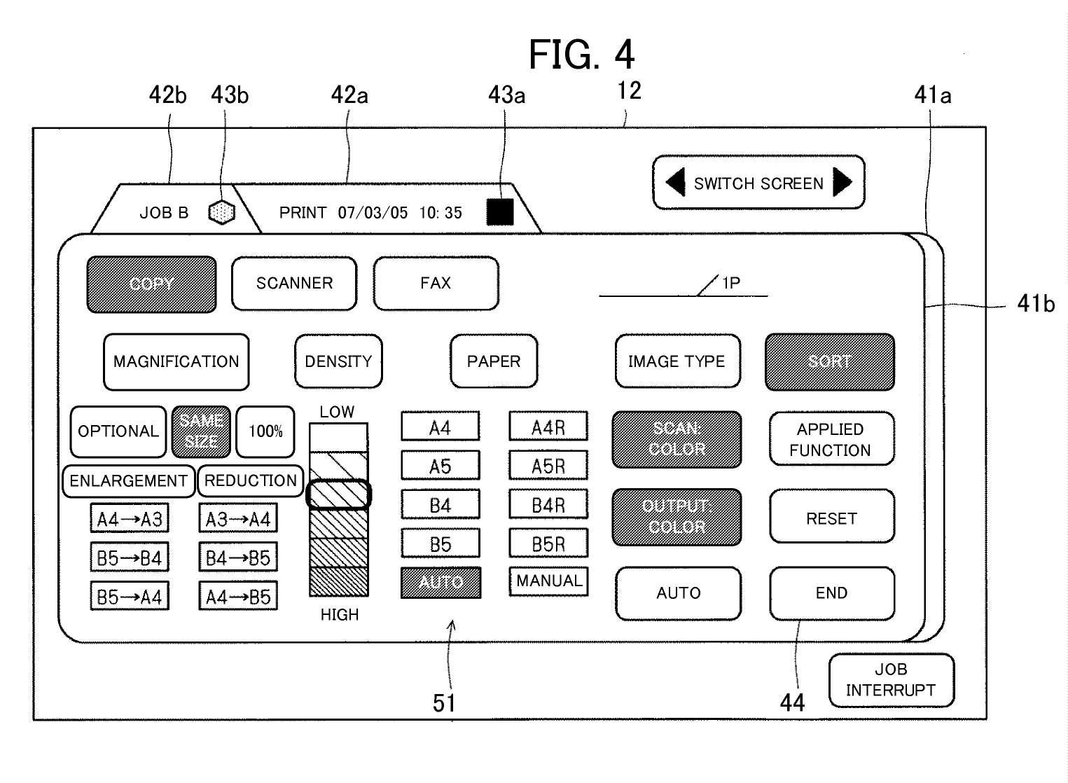

FIG. 4 illustrates the display items on the display 12, and FIG. 5 is a functional block diagram when the job interrupt command is entered. The multifunction peripheral device 10 includes the display controller 50. This is a functional block provided by operating according to a program stored in the ROM 24 while the MPU 23 is using the RAM 25 as a temporary processing section.

First, when no job is accepted, the display controller 50 displays a waiting screen such as a logo stored in the job setting storage unit 21 on the display 12. When an operation start command such as a job command is entered through the entry operation unit 11 or the touch panel on the display 12 in a state of displaying the waiting screen, the default setting content 220 is displayed on the display 12. When the job interrupt command is entered through the entry operation unit 11 or the touch panel of the display 12, the display controller 50 displays in a form in which the user can simultaneously see and confirm both the setting contents 22a, 22b, etc., which are set before the job interrupt is entered, and the default setting content 220, which is to be executed after the job interrupt command is entered. The setting contents are selectively activated and displayed on the display 12.

More specifically, the display controller 50 first displays the waiting screen such as the logo on the display 12. In this state, the display controller 50 accepts setting content information 51 indicating various settings such as job type, paper size, magnification, image type, printing density, and number of copies from the touch panel of the display unit 12 and displays the same in a frame 41a of the display 12. When job interrupt information 54 is entered before job execution command information 52 for the job A is entered or end command information 53 for the job A is entered, the display controller 50 transfers the setting content information 51 of the job A to the setting content 22a, stores the same in the job setting storage unit 21, creates a new frame 41b, and displays the default setting content 220 as active. The display controller 50 now accepts the settings only for either one of the frames 41a and 41b which are displayed as active. At this time, the frame 41a which is not active is attached with an identifier 42a and is displayed on the display 12 only with the identifier 42a.

When the job execution command information 52 is entered through the entry operation unit 11, the job is executed in association with the scanning unit 13 and the image drawing unit 16.

The identifier 42a includes a designation of the job and the stored date and time of the setting content 22a accepted in the frame 41a, and in the present preferred embodiment, is in the form of a so-called tag. The identifier 42a has also a function as a selection button for selecting the frame 41a as an active frame. In other words, when the user touches the identifier 42a, the frame 41a is activated (displayed as a top layer) by a touch panel function, and only the identifier 42b is displayed as a top layer as if the setting content 22b displayed in the frame 41b is stored in the job setting storage unit 21 and the frame 41b is displayed behind the frame 41a. In other words, the setting content of the frame 41a is displayed so as to hide at least a body portion of the display setting content of the frame 41b. However, the identifiers 42a, 42b are still displayed in parallel.

The information provided by the identifiers 42a, 42b do not have to be the designation or stored date and time of the jobs and may be icons corresponding to the respective jobs. The identifiers 42a, 42b may have identifiers corresponding to the setting contents instead of simply indicating the jobs. For example, when the setting content of the job A is to scan a binary image and output the binary image, an identifier 43a is provided. When the setting content of the job A is to scan a color image and output a gray scale image, an identifier 43b is provided.

In order to cancel or end the interrupt job, the end command information 53 is transmitted to the display controller 50 by pressing an “end” button 44 which is displayed on the entry operation unit 11 or either one of the active frames 41a, 41b. When the end command information 53 is transmitted, the display controller 50 deletes the active frame (the frame 41b in FIG. 4). At this time, when the setting contents 22a and 22b are stored in the job setting storage unit 21, one of the setting contents 22a and 22b (the setting content 22a corresponding to the frame 41a in FIG. 4) is invoked and is displayed on the display 12 as the active frame 41a. In a case in which none of the setting contents 22a and 22b is stored in the setting storage unit at the time when the end command information 53 is transmitted, the predetermined waiting screen such as the logo is displayed on the display 12.

### Operation of Multifunction Peripheral Device 10

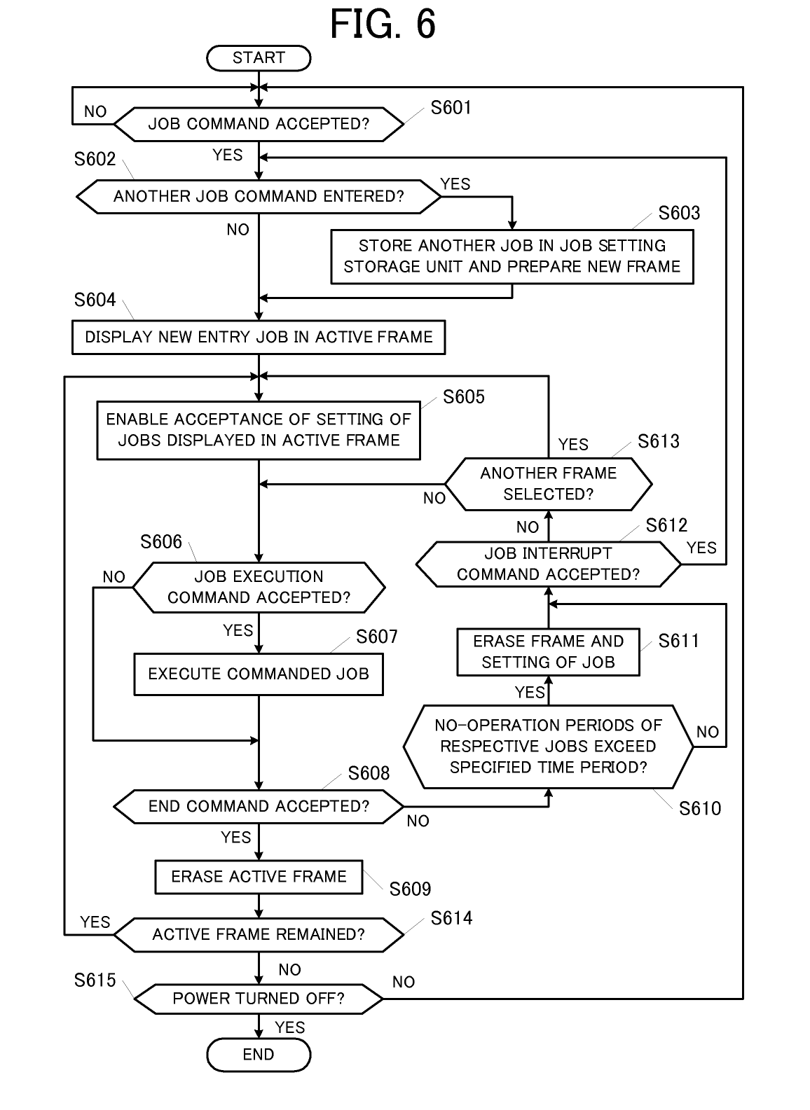

FIG. 6 is a flowchart of the job interrupt process. The multifunction peripheral device 10 executes the following operations with the provision of the configuration described above. In this flowchart, only the operations of the multifunction peripheral device 10 for processing the job interrupt is shown, and illustration and description of other process operations are omitted. A series of processing operations in the multifunction peripheral device 10 is executed automatically under the control of the MPU 23 unless otherwise specifically described.

First, the multifunction peripheral device 10 displays the waiting screen such as the logo on the display 12 in a state in which the power of the multifunction peripheral device 10 is ON. Then, the multifunction peripheral device 10 waits until the entry operation unit 11 or the touch panel of the display 12 accepts various settings (hereinafter, referred to as a “job command”) for executing a job (Step S601). When Yes is determined in Step S601 (that is, when the job command is accepted), whether or not other job commands are entered is determined (Step S602).

When Yes is determined in Step S602 (that is, when other job commands are entered), the setting content 22b accepted by the other job commands is stored in the job setting storage unit 21, and a new frame 41b is prepared (Step S603). In contrast, when No is determined in Step S602 (that is, other job commands are not entered), the new job entered in Step S601 is displayed in the active frame (Step S604) so that the settings of the job displayed on the active frame are ready to be accepted (Step S605). In this case, with regard to the job which the multifunction peripheral device 10 has accepted first, No is automatically selected in Step S602, and the procedure in Step S604 is executed.

In a state in Step S605, the setting content information 51 is accepted, and whether or not a job execution command is accepted is determined (Step S606) and, immediately, whether or not an end command is accepted is determined (Step S608). When Yes is determined in Step S606 (that is, when the job execution command is accepted), the multifunction peripheral device 10 executes a commanded job (Step S607). After execution of the job in Step S607 or when the end command is accepted without accepting the job execution command (that is, when Yes is determined in Step S608), the active frame 41b is deleted (Step S609).

When No is determined in Step S608 (that is, the end command is not accepted), whether or not the no-operation periods of the respective jobs exceed a predetermined specified time period is determined (Step S610). When the no-operation periods exceed the specified time period, Yes is determined in Step S610, and the frame and the settings of the corresponding job are deleted (Step S611). In contrast, when there is no job whose No-operation period exceeds the predetermined time period, No is determined in Step S610, and Step S611 is skipped. Subsequently, whether or not the job interrupt command is accepted is determined (Step S612) and, immediately, whether or not another frame 41a is selected is determined (Step S613).

When Yes is determined in Step S612 (that is, the job interrupt command is accepted), the procedure goes back to Step S602. When Yes is determined in Step S613 (that is, when the frame 41a is selected), the procedure goes back to Step S605. In contrast, when No is determined in Step S613 (that is, the frame 41a is not selected), the procedure goes back to Step S606.

When the active frame 41b is deleted in Step S609 after having repeated these steps, whether or not there is still an active frame is determined (Step S614). When Yes is determined, the frame of the job which used to be active immediately before accepting the job interrupt command is automatically selected, and then the procedure goes back to Step S605. In contrast, when No is determined in Step S614 (that is, there is no more active frames), whether or not the power is OFF is determined (Step S615).

When Yes is determined in Step S615, all the processes are ended. In contrast, when No is determined, the procedure goes back to Step S601, and the same process is repeated until Yes is determined in Step S615.

### Advantages of the First Preferred Embodiment

As described above, when the job interrupt command is entered, the setting contents 22a and 22b before the job interrupt command is entered and the default setting content 220 after the job interrupt command is entered are selectively displayed on the display 12. Therefore, when the user wants to restart the suspended job, the user is able to restart the job without confusion.

When the job interrupt command is entered, the new frame 41b is prepared and selectively displayed on the display 12. Therefore, even when the job interrupt command is entered, the setting content 22b is displayed in substantially the same size as the setting content 22a displayed before the job interrupt command is entered. Since the identifiers 42a, 42b, 43a, and 43b are attached to the display, the user is able to restart the job without confusion.

The job setting storage unit 21 holds the setting contents 22a and 22b stored in the job setting storage unit 21 when the job interrupt command is entered for the predetermined time period. Therefore, the user is able to execute the job by selecting and activating the frame without resetting if it is within the predetermined time period. Since the setting contents 22a and 22b are deleted after the predetermined time period is elapsed, memory capacity is saved.

### Second Preferred Embodiment

In the first preferred embodiment, an example in a case in which the job interrupt command is entered and a new frame is prepared for each job has been described. However, the present invention is not limited thereto. Referring to the drawings, as a second preferred embodiment of the present invention, an example will be made in which the display 12 is divided when a process of entering a user interrupt, i.e., a process of entering the job interrupt command is performed as a form of job interrupt. The components having the same functions as those in the first preferred embodiment are designated with the same reference numerals and the description thereof is omitted.

### Configuration of Multifunction Peripheral Device 70

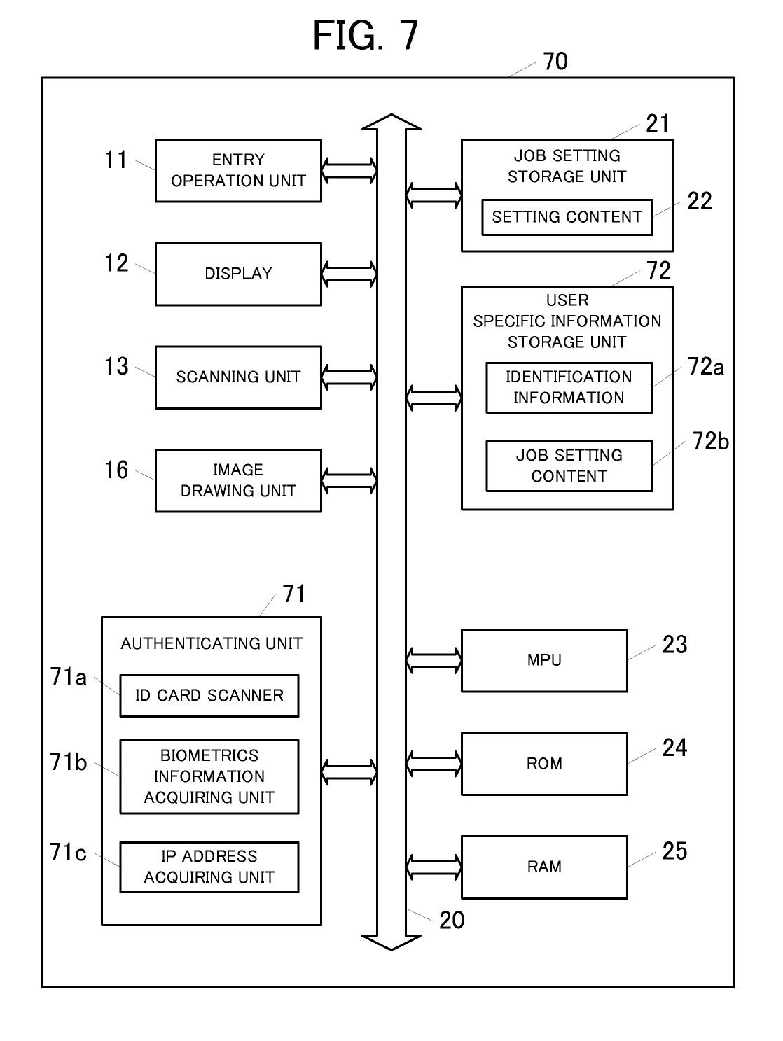

FIG. 7 is a block diagram illustrating an exemplified configuration of multifunction peripheral device 70 according to the second preferred embodiment of the present invention. The multifunction peripheral device 70 further includes an authenticating unit 71 and an identification information storage unit 72 in addition to the components in the multifunction peripheral device 10 in the first preferred embodiment.

The authenticating unit 71 authenticates the user stored in the identification information storage unit 72. For example, an identification (ID) card scanning unit 71a for scanning a Radio Frequency Identification (RFID) card (see FIG. 1) is provided and the user identification information stored in the identification information storage unit 72 and the scanned information are compared and authenticated. The authenticating unit 71 does not necessarily have to authenticate by scanning the RFID card (in general, ID storage device), and it may be done by password entry. In this case, the authenticating unit 71 authenticates the user on the basis of the password entered through the entry operation unit 11 or the touch panel of the display 12. The authenticating unit 71 may authenticate the user on the basis of the biometrics information acquired by providing a biometrics information acquiring unit 71b arranged to acquire the biometrics information such as fingerprints, voiceprints, or irises as needed. The authenticating unit 71 may also authenticate the user on the basis of IP addresses acquired by providing an IP address acquiring unit 71c arranged to acquire IP addresses specific for communication terminals to be connected via a network. The authenticating unit 71 includes at least one of the units shown above.

The identification information storage unit 72 is provided with a nonvolatile memory as in the case of the job setting storage unit 21 and stores user specific identification information 72a and the user specific job setting content 72b of a user who is capable of operating the multifunction peripheral device 10. The information stored as the identification information 72a is the identification information of the same type as the type of the identification information authenticated by the authenticating unit 71 (password, biometrics information, ID card information, IP address, etc.).

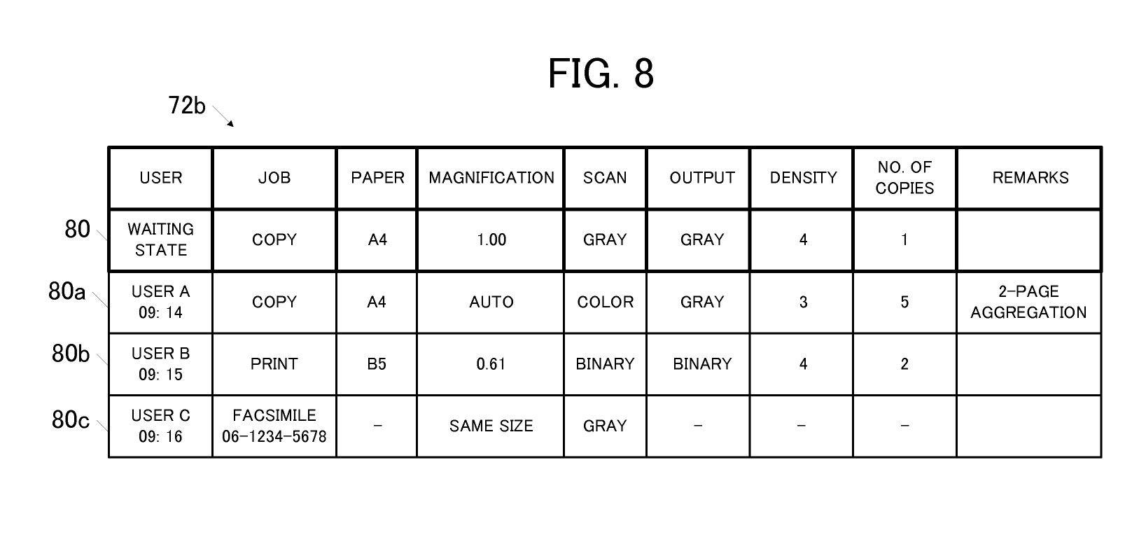

FIG. 8 is a table of the job setting content 72b. The information stored as the job setting content 72b includes, as illustrated in FIG. 8, the job, the paper size, the scaling magnification, image type, the printing density, the number of copies specified individually by the user, etc. For example, in many cases where the user A uses the multifunction peripheral device 70 and outputs five copies of two pages of color documents so as to be aggregated on one piece of paper of A4 size in gray scale image irrespective of the document size, the job setting content 72b to be stored includes, copying, A4, same size, color scan, color output, five copies, two pages aggregation.

### Function of Display Controller 100

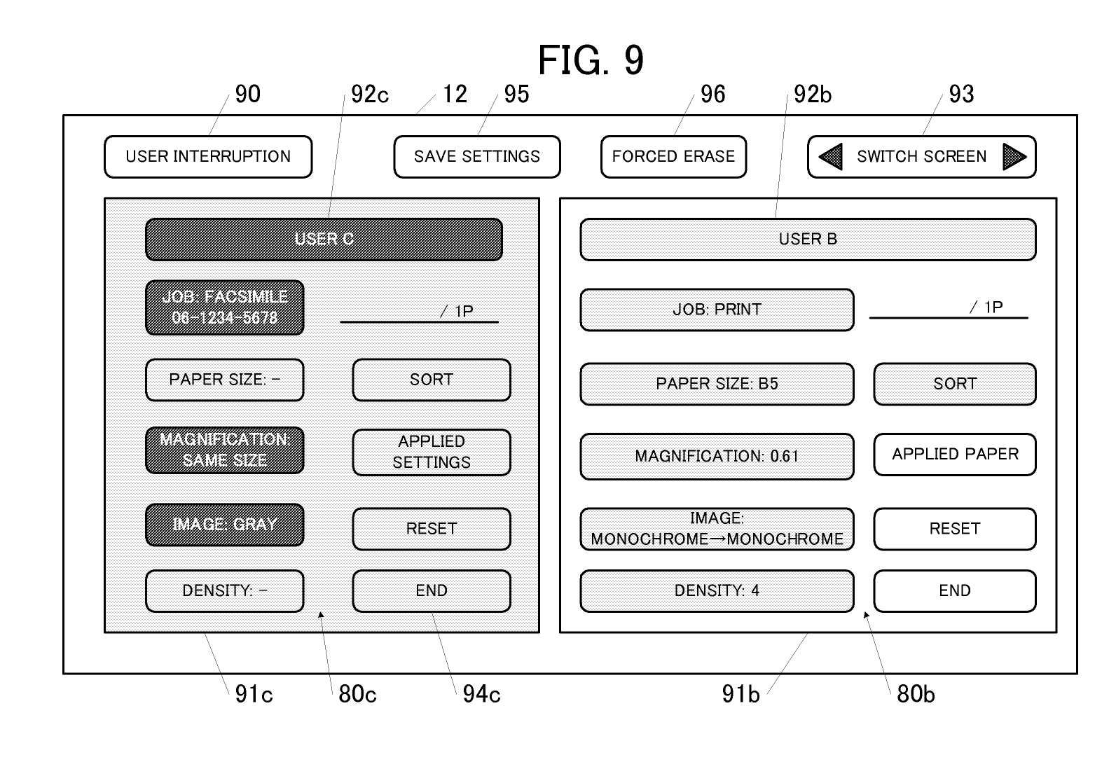

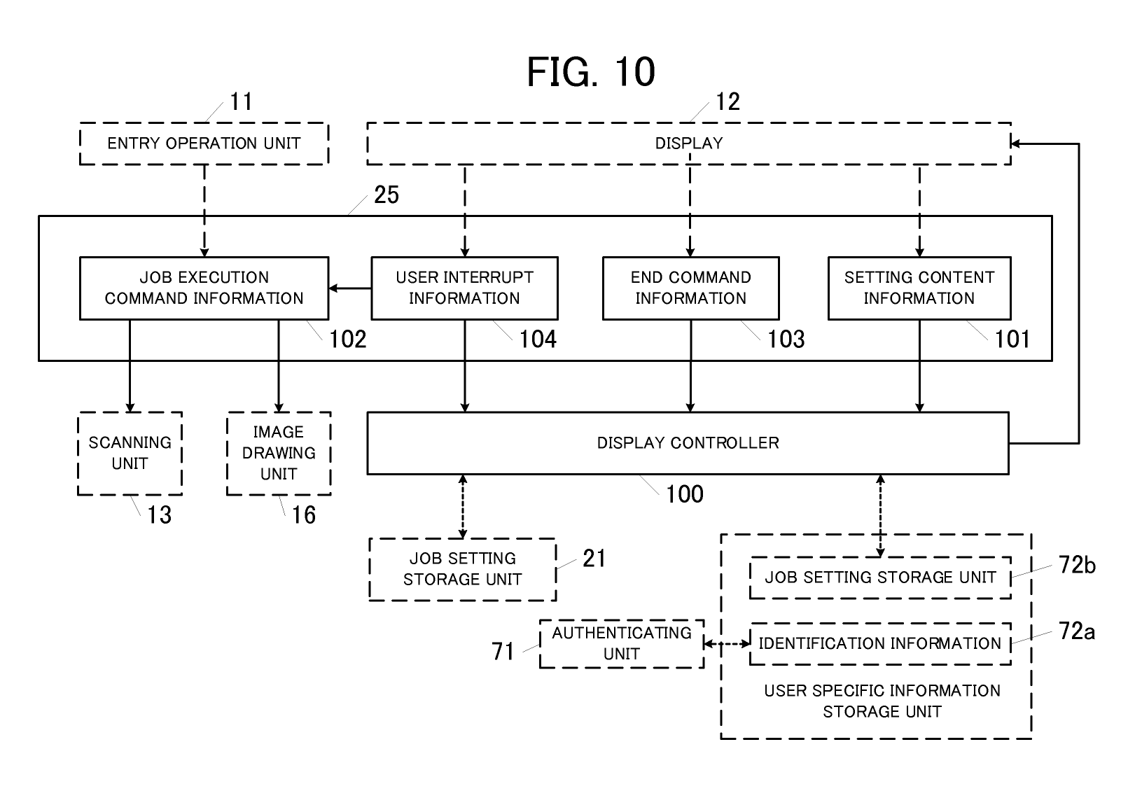

FIG. 9 illustrates the display content of the display 12, and FIG. 10 is a functional block diagram of a case in which a user interrupt command is entered. The multifunction peripheral device 70 includes a display controller 100.

The display controller 100 selectively displays job setting contents 80a, 80b, 80c . . . set by the user before the user interrupt command is entered and a job setting content 80 in a waiting state after the user interrupt command is entered when the user interrupt command is entered through the entry operation unit 11 or the touch panel of the display 12.

More specifically, first, the display controller 100 displays the job setting content 80a as a specific content of the authenticated user A on the display 12 when authenticated by the authenticating unit 71 and the identification information 72a and accepts a setting content information 101 and a job execution command information 102. Then, when a user interrupt button 90 displayed on the display 12 is pressed in a state in which the job setting content 80a of the user A is displayed, that is, in a state in which the job from the user A is acceptable, the display controller 100 accepts a user interrupt information 104.

When another user B is authenticated by the authenticating unit 71 and the identification information 72a, the display controller 100 divides a portion of the display screen of the display 12 and displays the job setting content before the user interrupt command is entered from the user B, that is, the job setting content 80a of the user A, and the setting content in the waiting state after the user interrupt command is entered (for example, the job setting content 80b of the user B) are displayed in parallel on the display 12 so as to allow the user to select the job. Here, the job setting content 80a of the user A is displayed on one of the divided screens (not illustrated) with the identifier (not illustrated) of the user A attached thereto, and the job setting content 80b of the user B is displayed on another divided screen 91b with a user identifier 92b attached thereto. The user identifiers 92b and 92c and the various settings (job, paper size, magnification, image type, print density, and the number of copies) displayed on the respective divided screens 91b and 91c are displayed hierarchically by pressing respective buttons, so that the change of settings is acceptable.

In a case in which the user interrupt command is entered by another user C in a state in which the jobs from the users A and B are acceptable, the new divided screen 91c having the job setting content 80c of the user C displayed thereon, and the divided screen 91a having the job setting content 80a of the user A and the job setting content 80b of the user B displayed thereon are selectively displayed on the display 12. By improving visibility by increasing the display density of the active divided screen (the divided screen 91c in FIG. 9) from between the divided screens 91b and 91c displayed on the display 12 or by displaying the active divided screen in a larger scale than the divided screen which is not active (the divided screen 91b in FIG. 9), the user is able to execute or restart the job without confusion.

In the present preferred embodiment, there are two divided screens 91b and 91c which are displayed simultaneously on the display 12, and the job setting content 80a of the user A is displayed by pressing a screen switching button 93. However, three or more divided screens 91a, 91b, and 91c may be displayed depending on the size of the displayable area of the display 12, or a new frame may be prepared for the job setting contents 72b from the third one onward to be selectively displayed in combination with the example shown in the first preferred embodiment.

When an “END” button 94c is pressed in the active divided screen 91c from between the divided screens 91b and 91c displayed on the display 12, the display controller 100 accepts the end command information 103, deletes the divided screen 91c, and displays the job setting content 80a of the user A on the display 12 in the same mode.

The display controller 100 displays a save settings button 95 on the display 12 and, when the save settings button 95 is pressed, saves the job setting content 80c of the user C which is displayed in the active divided screen 91c as the job setting content 72b, that is, as the setting content in the waiting state when the information of the user C is entered. At this time, the change of the job setting content 72b may be limited by executing the user authentication in the authenticating unit 71 again or by accepting entry of the password or the like for saving the job setting content 80c of the user C as the job setting content 72b and allows saving only when the password is authenticated.

The display controller 100 displays a forced erase button 96 on the display 12 and is able to forcedly erase a portion or the entire portion of the users who are accepted by the multifunction peripheral device 70 when the forced erase button 96 is pressed. Accordingly, the amount of used memory is minimized. In order to prevent unintended erasure due to the wrong operation or the like, the forced erase is limited to only when it is authenticated to be the operation by the authorized user or when the password is entered.

### Operation of Multifunction Peripheral Device 70

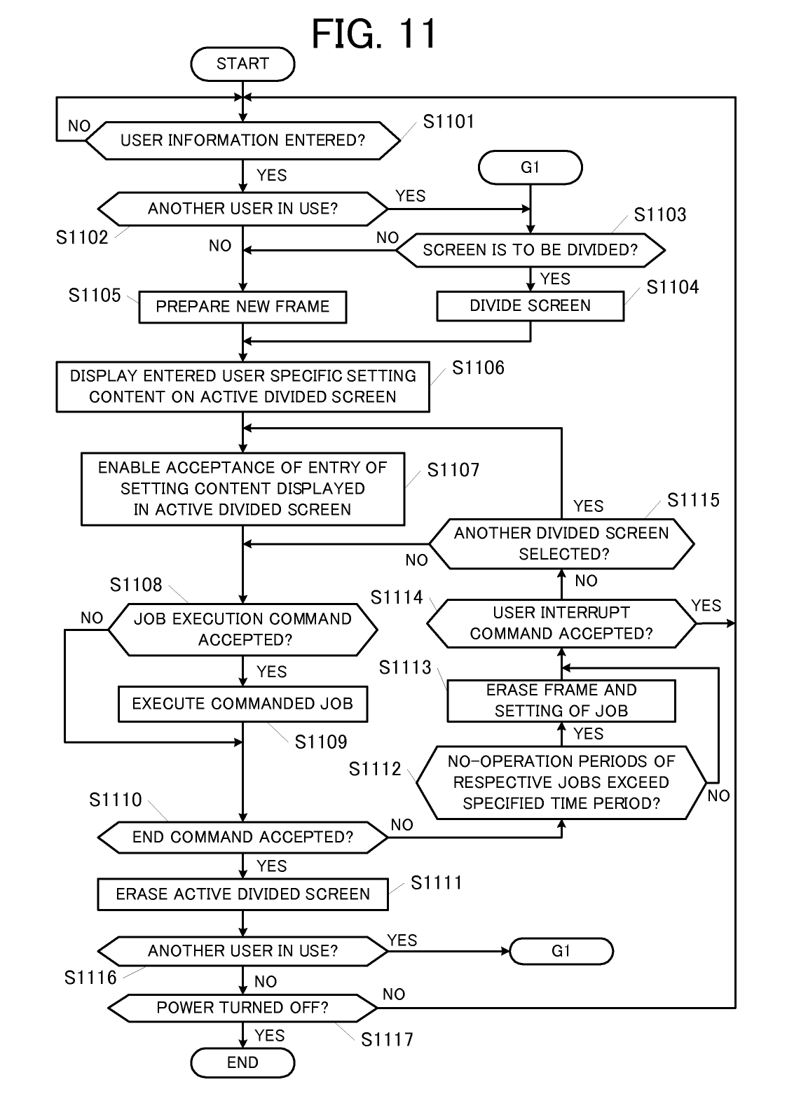

FIG. 11 is a flowchart of the user interrupt process. The multifunction peripheral device 70 configured as described above operates as follows. In this flowchart, only the operation of the multifunction peripheral device 70 to process the user interrupt is shown and illustration and description of other process operations are omitted. A series of processing operations in the multifunction peripheral device 70 is executed automatically under the control of MPU 23.

In the state in which the power of the multifunction peripheral device 70 is ON, the multifunction peripheral device 70 waits until the user information is entered through the ID card scanner 71a (Step S1101). When Yes is determined in Step S1101 (that is, when the user information is entered), whether or not another user is using the multifunction peripheral device 70 is determined (Step S1102). With regard to the user information that the multifunction peripheral device 70 is received at the beginning, No is automatically selected in Step S1102.

When Yes is determined in Step S1102 (that is, when another user is using the multifunction peripheral device 70), whether or not the screen of the display 12 is to be divided is determined (Step S1103). When Yes is determined, the display layout such as the screen division of the display 12 is determined (Step S1104), and the entered job setting content 80c of the user C is displayed in an active state (Step S1105). In contrast, when No is determined in Step S1103, a new frame is prepared (Step S1105), and the entered user specific setting content is displayed in an active state (Step S1106; see FIG. 4). In Step S1106, acceptance of entry to the job setting content 80c of the user C displayed on the displayed active frame or the active divided screen (hereinafter referred to as “active divided screen”) 91c is enabled (Step S1107).

Whether or not the job execution command is accepted is determined in the state of Step S1107 (Step S1108) and whether or not the end command is accepted is determined (Step S1110). When Yes is determined in Step S1108 (that is, when the job execution command is accepted), the commanded job is executed (Step S1109). After executing the job in Step S1109 or when the end command is accepted without accepting the job execution command (that is, Yes is determined in Step S1110), the active frame is erased (Step S1111).

When No is determined in Step S1110 (that is, when the end command is not accepted), whether or not the no-operation periods of the respective jobs exceed a predetermined specified time period is determined (Step S1112). When the no-operation periods exceed the specified time period, Yes is determined in Step S1112, and the frame and the settings of the corresponding jobs are erased (Step S1113). On the other hand, when there is no job whose no-operation period exceeds the specified time period, No is determined in Step S1112 and Step S1113 is skipped. Subsequently, whether or not the user interrupt command is accepted is determined (Step S1114) and, immediately, whether or not other divided screens 91b, etc., are selected is determined (Step S1115).

When Yes is determined in Step S1114 (that is, when the user interrupt command is accepted), the procedure goes back to Step S1101. When Yes is determined in Step S1115 (that is, when another divided screen 91b, etc. is selected), the procedure goes back to Step S1107. In contrast, when No is determined in Step S1115, the procedure goes back to Step S1108.

After having repeated these processes, when the active divided screen 91c is erased in Step S1111, whether or not another user is using the multifunction peripheral device 70 is determined (Step S1116), and when Yes is determined, the frame of the job which has been active immediately before the job interrupt command is accepted is automatically selected and the procedure goes to Step S1103. In contrast, when No is determined in Step S1116 (that is, when there is no other user using the multifunction peripheral device 70), whether or not the power is turned OFF is determined (Step S1117).

When Yes is determined in Step S1117, all the processes are ended. In contrast, when No is determined, the procedure goes back to Step S1101, and the same processes are repeated until Yes is determined in the Step S1117.

### Advantages of the Second Preferred Embodiment

As described thus far, when the user interrupt command is entered, the display 12 is divided and the job setting content 80b before the entry of the user interrupt command and the job setting content 80c in the waiting state after the entry of the user interrupt command are selectively displayed. Therefore, the user is able to recognize that the user interrupt command is entered with ease.

When the user is authenticated by the authenticating unit 71, the job setting content 72b is displayed with the user identifiers 92b and 92c attached thereon, even when the job is suspended, the user is able to restart the job without confusion.

The authenticating unit 71 authenticates the user by at least one of the password, the biometrics information, the ID card (ID storage device), and the IP address of the communication terminal connected via the network, and the identification information storage unit 72 accepts the change of the identification information 72a of the user and the job setting content 72b stored in the identification information storage unit 72 only when the user is authenticated by the authenticating unit 71. Therefore, the respective users are able to use the multifunction peripheral device 70 comfortably and without being confused.

### Modifications

Although preferred embodiments of the present invention have been described thus far, the invention is not limited to the above-describe preferred embodiments. For example, it is also possible to combine the first and second preferred embodiments and accept the job interrupt command even for the same user to enable execution of the interrupt job.

Furthermore, a circuit configuration in which the above-described processes are achieved is also applicable, and the present invention is not limited to the respective steps shown above.

While the present invention has been described with respect to preferred embodiments thereof, it will be apparent to those skilled in the art that the disclosed invention may be modified in numerous ways and may assume many embodiments other than those specifically set out and described above. Accordingly, it is intended by the appended claims are intended to cover all modifications of the present invention that fall within the true spirit and scope of the present invention.

What is claimed is:

1. A job interruptible image forming device comprising:
a job setting storing unit arranged to store contents of respective job settings of at least an interrupted first job and an interrupting second job;
a display controller arranged to cause a display to indicate that the respective job settings of the first job and the second job coexist; and
a selective activating unit arranged to activate job setting windows for the respective job settings selectively on the display in response to a selection entry of a user.

2. The image forming device according to claim 1, wherein the display controller controls the display to cause the respective job settings to coexist by simultaneously displaying respective identifiers of the first job and the second job in parallel.

3. The image forming device according to claim 1, wherein the display controller controls the display to display the job setting window for the second job so as to hide at least a portion of the job setting window for the first job.

4. The image forming device according to claim 2, wherein the display controller controls the display to display the job setting window for the second job so as to hide at least a portion of the job setting window for the first job.

5. The image forming device according to claim 1, wherein the display controller controls the display to simultaneously display the respective job setting windows for the first job and the second job in parallel.

6. The image forming device according to claim 2, wherein the display controller controls the display to simultaneously display the respective job setting windows for the first job and the second job in parallel.

7. The image forming device according to claim 3, wherein the display controller controls the display to simultaneously display the respective job setting windows for the first job and the second job in parallel.

8. The image forming device according to claim 4, wherein the display controller controls the display to simultaneously display the respective job setting windows for the first job and the second job in parallel.

9. The image forming device according to claim 5, wherein the display controller controls the display to display an active job setting window so as to be identifiable from a location between the respective job setting windows displayed in parallel.

10. The image forming device according to claim 6, wherein the display controller controls the display to display an active job setting window so as to be identifiable from a location between the respective job setting windows displayed in parallel.

11. The image forming device according to claim 7, wherein the display controller controls the display to display an active job setting window so as to be identifiable from a location between the respective job setting windows displayed in parallel.

12. The image forming device according to claim 8, wherein the display controller controls the display to display an active job setting window so as to be identifiable from a location between the respective job setting windows displayed in parallel.

13. The image forming device according to claim 1, further comprising:
a user specific information storage unit arranged to store identification information of the respective users of the image forming device and job setting content specific for the respective users of the image forming device; and
an authenticating unit arranged to authenticate the users stored in the user specific information storage unit; wherein
the display controller controls the display when the user is authenticated by the authenticating unit to display the user specific job setting content with a user identifier.

14. The image forming device according to claim 2, further comprising:
a user specific information storage unit arranged to store identification information of the respective users of the image forming device and job setting content specific for the respective users of the image forming device; and
an authenticating unit arranged to authenticate the users stored in the user specific information storage unit; wherein
the display controller controls the display when the user is authenticated by the authenticating unit to display the user specific job setting content with a user identifier.

15. The image forming device according to claim 3, further comprising:
a user specific information storage unit arranged to store identification information of the respective users of the image forming device and job setting content specific for the respective users of the image forming device; and
an authenticating unit arranged to authenticate the users stored in the user specific information storage unit; wherein
the display controller controls the display when the user is authenticated by the authenticating unit to display the user specific job setting content with a user identifier.

16. The image forming device according to claim 7, further comprising:
a user specific information storage unit arranged to store identification information of the respective users of the image forming device and job setting content specific for the respective users of the image forming device; and
an authenticating unit arranged to authenticate the users stored in the user specific information storage unit; wherein
the display controller controls the display when the user is authenticated by the authenticating unit to display the user specific job setting content with a user identifier.

17. The image forming device according to claim 11, further comprising:
a user specific information storage unit arranged to store identification information of the respective users of the image forming device and job setting content specific for the respective users of the image forming device; and
an authenticating unit arranged to authenticate the users stored in the user specific information storage unit; wherein
the display controller controls the display when the user is authenticated by the authenticating unit to display the user specific job setting content with a user identifier.

18. The image forming device according to claim 13, wherein the authenticating unit includes an ID information acquiring unit, wherein the user specific information storing unit accepts a change of the user identification information and the user specific job setting content stored in the user specific information storing unit only when the user is authenticated by the authenticating unit.

19. The image forming device according to claim 18, wherein the ID information acquiring unit includes a password accepting unit arranged to accept passwords.

20. The image forming device according to claim 18, wherein the ID information acquiring unit includes a biometrics information acquiring unit arranged to accept biometrics information of the user.

21. The image forming device according to claim 18, wherein the ID information acquiring unit includes an ID scanner arranged to scan identification information from an ID storage device.

22. The image forming device according to claim 18, wherein the ID information acquiring unit includes a password accepting unit arranged to accept an IP address acquiring unit password for acquiring a communication terminal specific IP address connected to the image forming device via a network.

23. The image forming device according to claim 18, wherein the selective activating unit activates a job setting screen of the user on the display only when the user is authenticated by the authenticating unit.

24. The image forming device according to claim 1, further comprising a storage time limiting unit arranged to store the job setting of the first job in the job setting storing unit only for a predetermined time period from an entry of a job interrupt command of the second job.

25. The image forming device according to claim 2, further comprising a storage time limiting unit arranged to store the job setting of the first job in the job setting storage unit only for a predetermined time period from an entry of a job interrupt command of the second job.

26. A method of controlling a job interruptible image forming device in which job interrupting is enabled, the method comprising:
a step of storing contents of respective job settings of at least an interrupted first job and an interrupting second job;
a step of causing a display to indicate that the respective job settings of the first job and the second job coexist; and
a step of activating job setting windows for the respective job settings selectively on the display in response to a selection entry of a user.

27. The method of controlling according to claim 26, further comprising a step of indicating the coexistence of the respective job settings by simultaneously displaying respective identifiers of the first job and the second job in parallel.

28. The method of controlling according to claim 26, further comprising a step of displaying a job setting screen of the second job so as to hide a main portion of at least the job setting of the job setting screen of the first job.

29. The method of controlling according to claim 27, further comprising a step of displaying a job setting screen of the second job so as to hide a main portion of at least the job setting of the job setting screen of the first job.

30. The method of controlling according to claim 26, further comprising a step of simultaneously displaying the respective job setting windows for the first job and the second job in parallel.

31. The method of controlling according to claim 27, further comprising a step of simultaneously displaying the respective job setting windows for the first job and the second job in parallel.

32. The method of controlling according to claim 28, further comprising a step of simultaneously displaying the respective job setting windows for the first job and the second job in parallel.

33. The method of controlling according to claim 29, further comprising a step of simultaneously displaying the respective job setting windows for the first job and the second job in parallel.

34. The method of controlling according to claim 30, further comprising a step of displaying an active job setting window so as to be identifiable from between the respective job setting windows displayed in parallel.

35. The method of controlling according to claim 31, further comprising a step of displaying an active job setting window so as to be identifiable from a location between the respective job setting windows displayed in parallel.

36. The method of controlling according to claim 32, further comprising a step of displaying an active job setting window so as to be identifiable from a location between the respective job setting windows displayed in parallel.

37. The method of controlling according to claim 33, further comprising a step of displaying an active job setting window so as to be identifiable from a location between the respective job setting windows displayed in parallel.

38. The method of controlling according to claim 26, further comprising:
a step of authenticating the user; and
a step of displaying a job setting content specific for the user with a user identifier attached thereto by controlling the display when the user is authenticated.
